(19) United States
(12) Patent Application Publication
(10) Pub. No.: US 2015/0197120 A1
(43) Pub. Date: Jul. 16, 2015

(54) BICYCLE HUB SEALING STRUCTURES

(71) Applicant: Shih-Wei Chen, ShenZhen (CN)

(72) Inventor: Shih-Wei Chen, ShenZhen (CN)

(21) Appl. No.: 14/156,450

(22) Filed: Jan. 16, 2014

(51) Int. Cl. B60B 27/00; B60B 27/02

(52) U.S. Cl. CPC B60B 27/0073; B60B 27/0005; B60B 27/023; B60Y 2200/13; B60B 2900/211

(57) ABSTRACT

A bicycle hub sealing structure comprises: axle shaft, nuts, hub enclosure, a sleeve and a ratchet wheel, wherein, the hub enclosure rear end and the sleeve front end are attached to the axle shaft respectively through the first ball bearing and the second ball bearing, meanwhile the second ball bearing is combined with the sleeve through the balls, the nuts are positioned on the front and rear ends of the axle shaft, the rear end of the ratchet wheel is located inside the hub enclosure, and is combined with the sleeve through the balls, the front end of the hub enclosure has a housing cavity, the rear end of the sleeve is extended into the bulge loop inside the housing cavity, a sleeve oil seal is provided between the bulge loop outside wall and the housing cavity inside wall, and a leakage-proof gasket is provided between the bulge loop inside wall and the ratchet wheel.

### BACKGROUND OF INVENTION

1. Field of the Invention

The present invention relates generally to the technical field of bicycle parts, and more particularly to innovative bicycle hub sealing structures.

2. Description of Related Art

The hub is an important component to connect the axle shaft and the spokes in the structure of a bicycle. Its quality has a direct influence on the performance of the bicycle. During usage of the bicycle, the hub is subject to water, dust and other objects. Therefore, how to isolate the internal structure of the hub from the outer environment has become a subject of research for manufacturers.

In the bicycle hub commonly seen in the present market, the sealing between the sleeve and the ratchet wheel is not so good. Water, dust or other objects can easily enter the ratchet wheel, not only affecting the performance of the hub, but also reducing the lifecycle of the hub. Therefore, there is a need for improvement.

### SUMMARY OF THE INVENTION

In view of the deficiency of the existing technique, the objective of the present invention is to provide a new bicycle hub sealing structure featuring simple and compact structure as well as enhanced sealing effect.

To accomplish the above objective, the bicycle hub sealing structure of the present invention comprises: axle shaft, nuts, hub enclosure, sleeve and ratchet wheel, wherein, the hub enclosure rear end and the sleeve front end are attached to the axle shaft respectively through the first ball bearing and the second ball bearing, meanwhile the second ball bearing is combined with the sleeve through the balls, the nuts are positioned on the front and rear ends of the axle shaft, the rear end of the ratchet wheel is located inside the hub enclosure, and is combined with the sleeve through the balls, the front end of the hub enclosure has a housing cavity, the rear end of the sleeve is extended into the bulge loop inside the housing cavity, a sleeve oil seal is provided between the bulge loop outside wall and the housing cavity inside wall, and a leakage-proof gasket is provided between the bulge loop inside wall and the ratchet wheel.

The present invention has the following beneficial effects: the front end of the hub enclosure is formed with a housing cavity, the rear end sleeve is formed with a bulge loop extending into the housing cavity, and a sleeve oil seal is provided between the outside wall of the bulge loop and the inside wall of the housing cavity, a leakage-proof gasket is provided between the inside wall of the bulge loop and the ratchet wheel, so as to achieve a double-sealing effect for the ratchet wheel. With a simple and compact structure, the effect is very good.

The lower end of the above-mentioned sleeve oil seal is fitted on the outside wall of the bulge loop, the outside end is an elastic bent portion, resisting against the inside wall of the housing cavity 31 for sealing.

The above-mentioned bent portion is bent toward the outside of the outside of the housing cavity of the hub enclosure, and forms an acute angle with the main body of the sleeve oil seal.

The bottom and rear end of the above-mentioned leakage-proof gasket are respectively fitted on the bottom end face of the housing cavity and the external end face of the ratchet wheel, on the middle position, a seal is formed. The top of the seal resists against the inside wall of the bulge loop.

The above-mentioned seal is in an arc shape, with its opening facing toward the bottom end face of the housing cavity.

The rear end of the above-mentioned ratchet wheel is connected to the ratchet wheel mounting nut on the axle shaft through threaded joint. The ratchet wheel mounting nut is positioned by the step on the inside wall of the hub enclosure.

Inside the above-mentioned hub enclosure and the sleeve and outside the first ball bearing and second ball bearing, a first layer sealing device and second layer sealing device are respectively provided.

The above-mentioned first layer sealing device and the second layer sealing device are made up of two plane oil seals or one plane oil seal and one waterproof cover.

The above-mentioned first layer sealing device and the second layer sealing device are of the same structure.

The above-mentioned first layer sealing device and the second layer sealing device are of different structures.

### BRIEF DESCRIPTION OF THE DRAWINGS

FIG. 1 is a schematic view of Embodiment 1 of the present invention.

FIG. 2 is a partially enlarged view of Position A in FIG. 1.

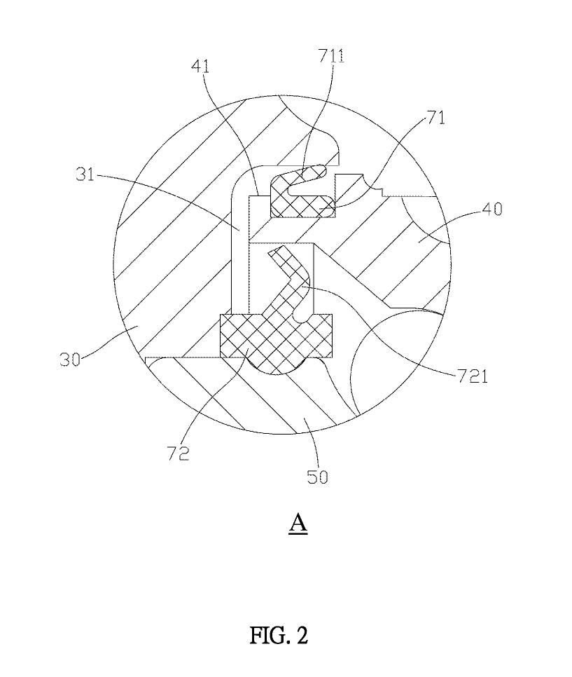

FIG. 3 is a schematic view of Embodiment 2 of the present invention.

FIG. 4 is a schematic view of Embodiment 3 of the present invention.

FIG. 5 is a schematic view of Embodiment 4 of the present invention.

FIG. 6 is a schematic view of Embodiment 5 of the present invention.

FIG. 7 is a schematic view of Embodiment 6 of the present invention.

FIG. 8 is a schematic view of Embodiment 7 of the present invention.

### DETAILED DESCRIPTION OF THE PREFERRED EMBODIMENT

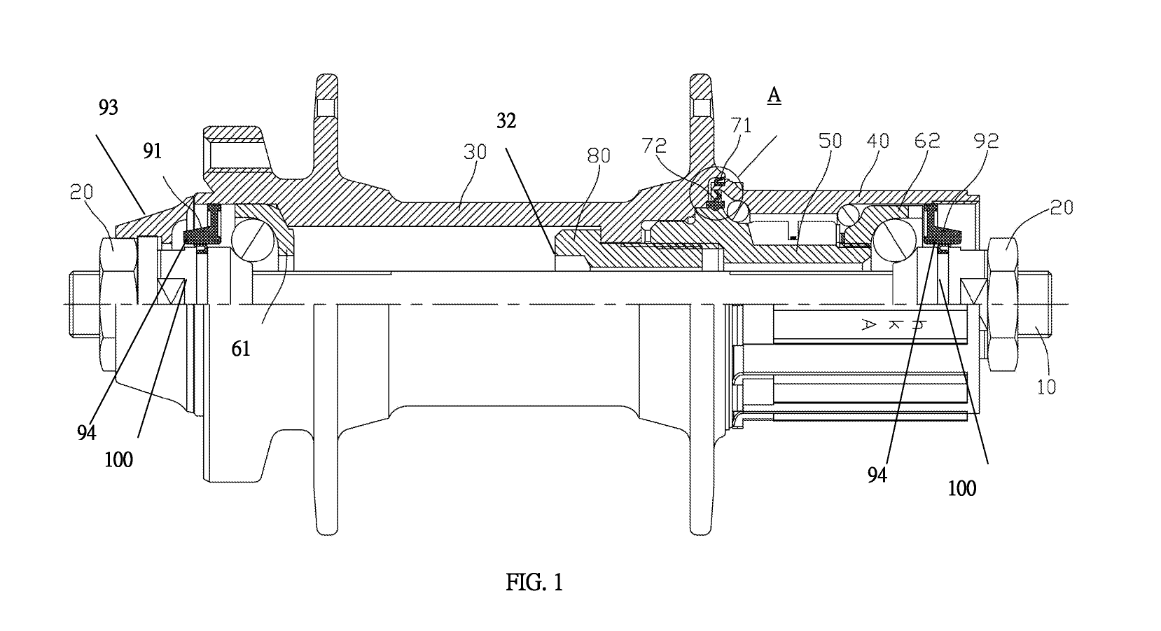

The following are only preferred embodiments based on the principle of the present invention and are not intending to limit the scope of the present invention. FIGS. 1˜2 depict Embodiment 1 of the bicycle hub sealing structure of the present invention, which comprises axle shaft 10, nuts 20, hub enclosure 30, sleeve 40 and ratchet wheel 50. The front and rear ends of the axle shaft 10 are respectively attached to the rear end of the hub enclosure 30 and the front end of the sleeve 40 through a first ball bearing 61 and a second ball bearing 62, and are respectively locked on the front and rear ends of the axle shaft 10 through the nuts 20, meanwhile the second ball bearing 62 is attached to the sleeve 40 through the balls; the rear end of the ratchet wheel 50 is set inside the hub enclosure 30, and is attached to the sleeve 40 through the balls at the central position of the ratchet wheel 50, the inside wall of the hub enclosure 30 is configured with a step 32, on the axle shaft 10, a ratchet wheel mounting nut 80 is provided, the ratchet wheel 50 is fixed on the step 32 through its rear end, and is connected to the ratchet wheel mounting nut 80 on the axle shaft 10 through threaded joint; the front end of the hub enclosure 30 has a housing cavity 31, the rear end of the sleeve 40 is formed with a bulge loop 41, and is extending into the housing cavity 31, between the outside wall of the bulge loop 41 and the inside wall of the housing cavity 31, a sleeve oil seal 71 is provided. Further, between the inside wall of the bulge loop 41 and the ratchet wheel 50, a leakage-proof gasket 72 is provided, and the bottom and rear end of the leakage-proof gasket 72 are respectively fitted on the bottom end face of the housing cavity 31 and the external end face of the ratchet wheel 50, on the middle position, a seal 721 is formed. The seal 721 is in an arc shape, with its opening facing toward the bottom end face of the housing cavity 31. The top of the seal 721 resists against the inside wall of the bulge loop 41. The inside end of the sleeve oil seal 71 is fitted on the outside wall of the bulge loop 41, while the outside end is an elastic bent portion 711, forming an acute angle with the main body of the sleeve oil seal 71. The bent portion 711 of the sleeve oil seal 71 is bent toward the outside of the housing cavity 31 of the hub enclosure 30, and resists against the inside wall of the housing cavity 31 to accomplish a sealing effect.

The shape and structure of the sleeve oil seal 71 and the leakage-proof gasket 72 of the present invention can prevent foreign objects to enter into the hub enclosure 30, meanwhile, the elasticity of the bent portion 711 and the seal 721 will not affect the relative rotation of the various parts inside the hub enclosure 30, so that the riding of the bicycle is more smooth.

In the present invention, inside the hub enclosure 30 and the sleeve 40 and outside the first ball bearing 61 and the second ball bearing 62, a first layer sealing device 91 and a second layer sealing device 92 are respectively provided. The first layer sealing device 91 and the second layer sealing device 92 can be made up of two plane oil seals or one plane oil seal and one waterproof cover. The first layer sealing device 91 and second layer sealing device 92 configured on the left and right sides of the hub enclosure 30 can be of the same structure or of different structures.

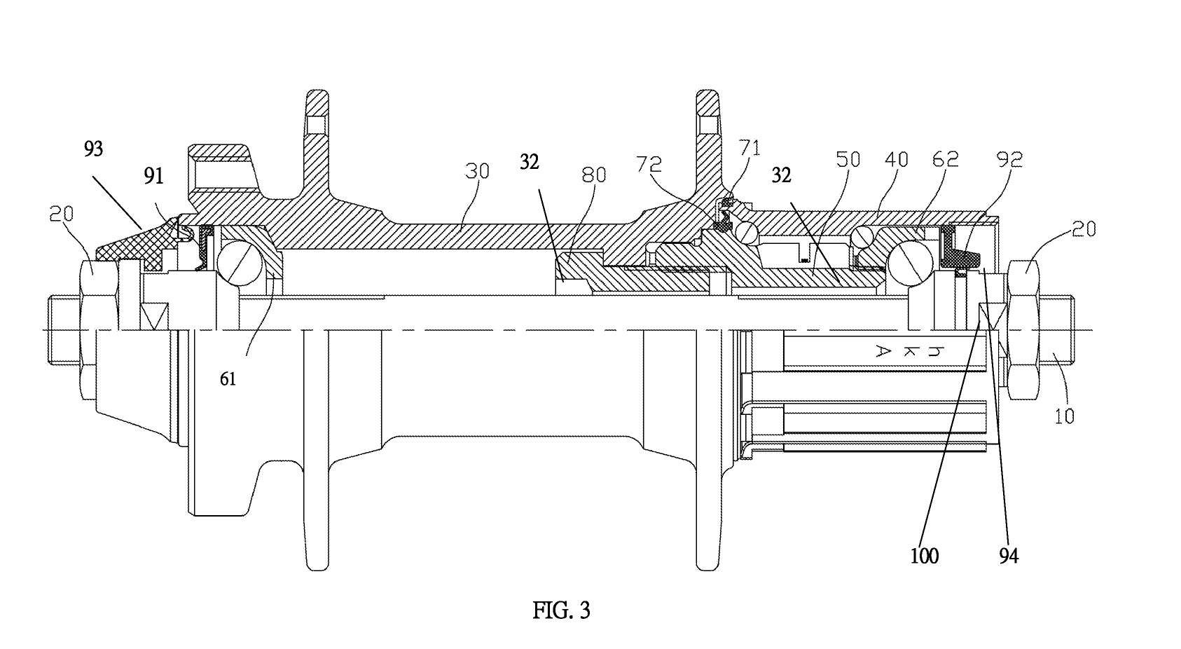

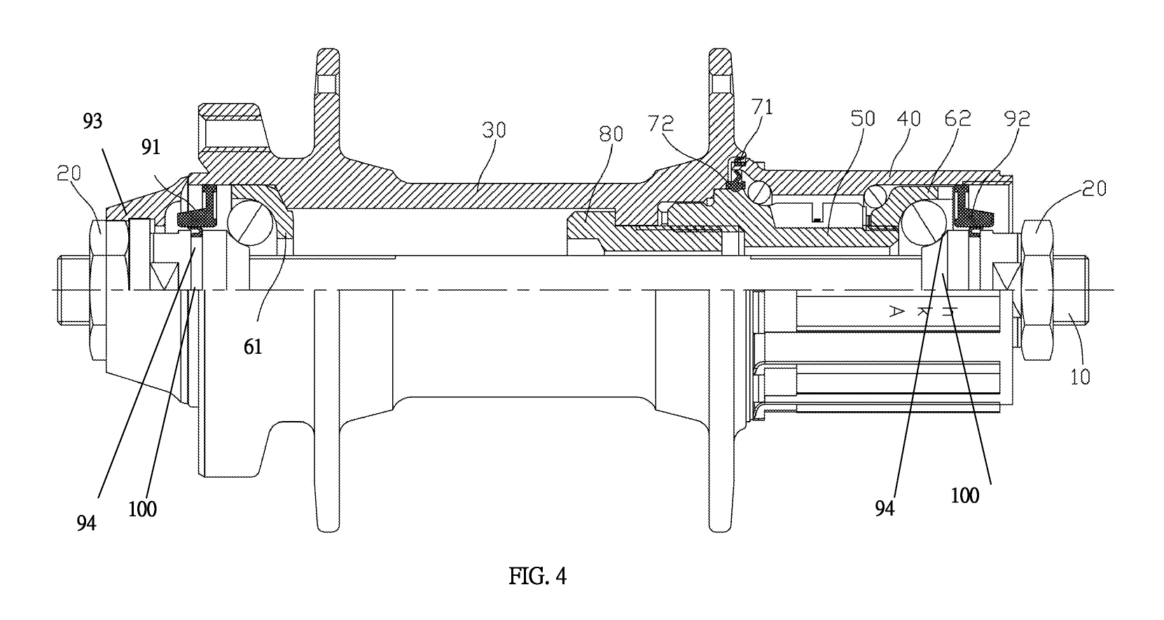

FIGS. 3˜8 depict various embodiments with different styles of the first layer sealing device 91 and the second layer sealing device 92. FIG. 4 is of the same structure as FIG. 1. The outside of the first layer sealing device 91 is configured with an axle cap 93 sealing the hub enclosure 30, and the inside space of the axle cap 93 can hold the first layer sealing device 91; Referring to FIG. 3, in Embodiment 2, the first layer sealing device 91 and the second layer sealing device 92 are respectively sealed on the outsides of the first ball bearing 61 and the second ball bearing 62, wherein, the first layer sealing device 91 is fitted on the axle shaft 10, with its periphery having a certain thickness and resisting against the inside wall of the hub enclosure 30, the second layer sealing device 92 is configured with a snap 94 on its inner side to fit with a groove 100 provided on the axle shaft 10, with its periphery having a certain thickness and resisting against the inside wall of the hub enclosure 30; Referring to FIG. 4, Embodiment 3 adopts the structure of the second layer sealing device 92 in FIG. 3, sealing on the outsides of the first ball bearing 61 and the second ball bearing 62, and further fitted through the snap 94 into the grooves 100 provided on periphery of the front and rear ends of the axle shaft 10.

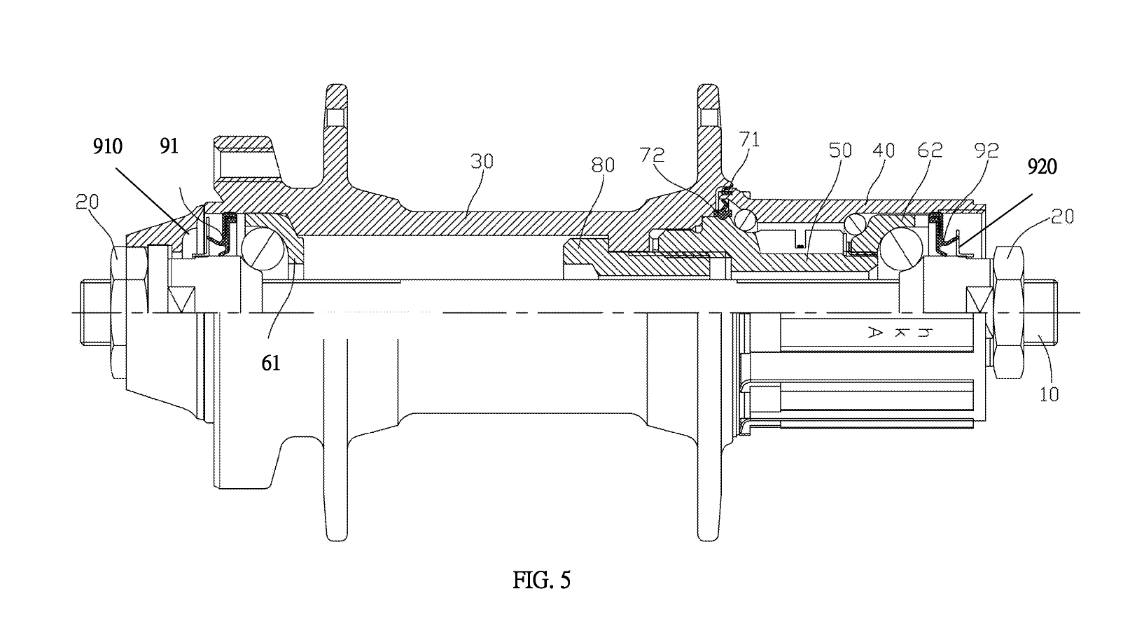

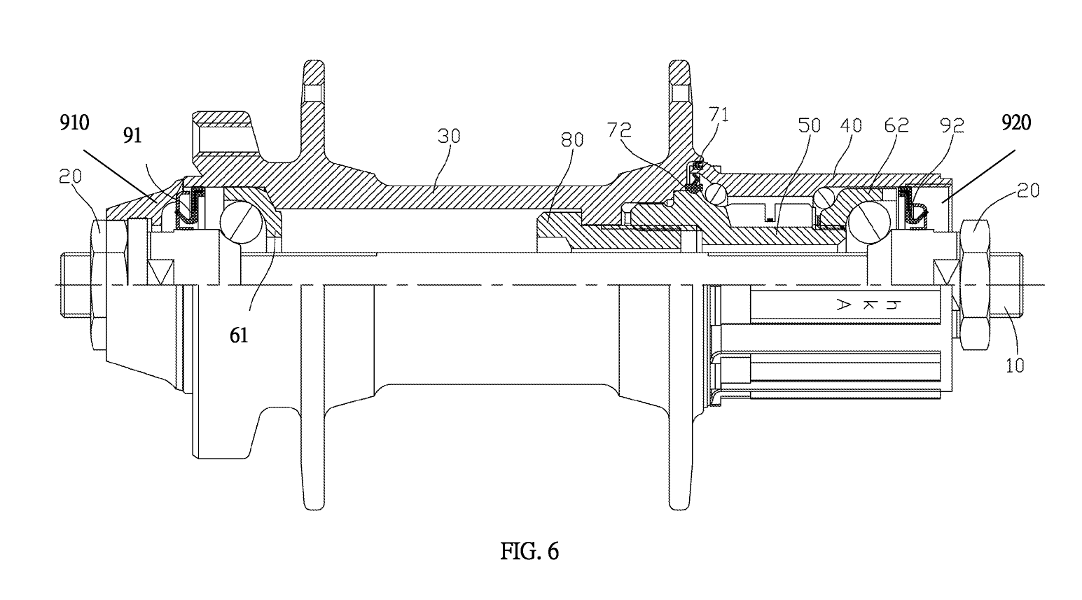

Referring to FIG. 5, in Embodiment 4, the first layer sealing device 91 and the second layer sealing device 92 respectively sealing on the outsides of the first ball bearing 61 and the second ball bearing 62 are of the same structure, with the outside of its inside end provided with an L-shaped waterproof cover 910. The waterproof cover 920 is fitted on the axle shaft 10 in the center of the hub enclosure 30; similarly, in Embodiment 5, as the waterproof cover 910 shown in FIG. 6, the waterproof cover 920 is in a [symbol] shape, and is fitted on the axle shaft 10 in the center of the hub enclosure 30.

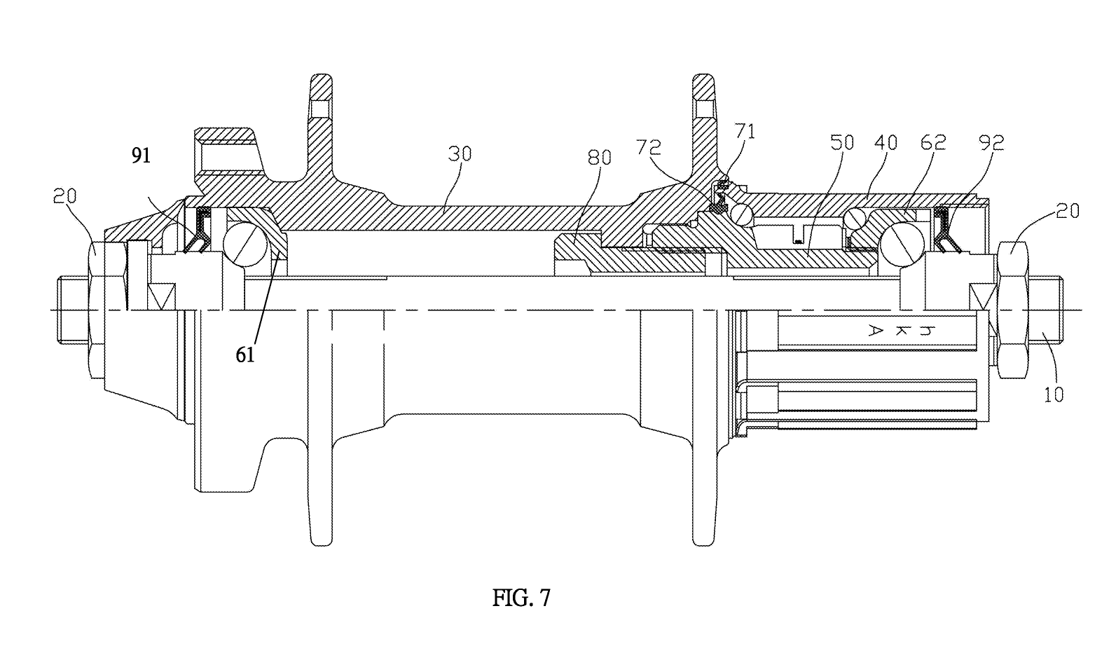

Referring to FIG. 7, in Embodiment 6, the first layer sealing device 91 and the second layer sealing device 92 are of the same structure. In the partially enlarged view, its inside end has a concave bevel 95, with the two ends of the concave bevel resisting against surface of the axle shaft 10 to enhance the sealing effect, and with its periphery having a certain thickness and resisting against the inside wall of the hub enclosure 30.

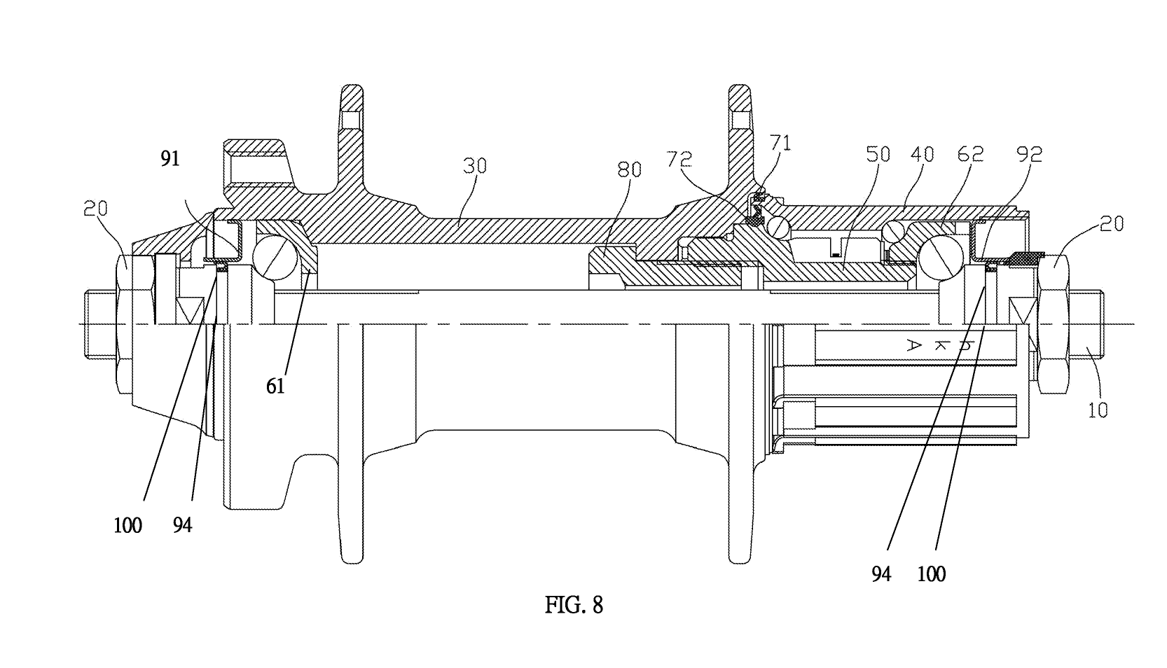

Referring to FIG. 8, in Embodiment 7, the first layer sealing device 91 and the second layer sealing device 92 are basically of the same structure, with a difference that the second layer sealing device 92 is further configured with an extending portion 921. In the partial sectional view, the first layer sealing device 91 and the second layer sealing device 92 are in an L shape, on the inner sides resisting on the axle shaft 10, the peripheries are provided with snaps 94, respectively fitting into the grooves 100 provided on the peripheries of the first ball bearing 61 and the second ball bearing 62, and with the peripheries of the first layer sealing device 91 and the second layer sealing device 92 having a certain thickness and resisting against the inside wall of the hub enclosure 30.

However, all the above described are only preferred embodiments to disclose the present invention. All equivalent modifications or variations made on the basis of the descriptions and drawings of the present invention shall fall within the scope of the present invention and be claimed.

1. A bicycle hub sealing structure, comprising an axle shaft, a hub enclosure, a sleeve, and a ratchet wheel, wherein, the front and rear ends of the axle shaft are respectively connected to the rear end of the hub enclosure and the front end of the sleeve through a first ball bearing and a second ball bearing, and are locked on the front end and rear end of the axle shaft through a nut, meanwhile, the second ball bearing is combined with the sleeve through the balls, the rear end of the ratchet wheel is located inside the hub enclosure, and is combined with the sleeve through the balls; main characteristics: the front end of the hub enclosure has a housing cavity, the rear end of the sleeve is formed with a bulge loop extending into the housing cavity; between the outside wall of the bulge loop and the inside wall of the housing cavity, a sleeve oil seal is provided, and between the inside wall of the bulge loop and the ratchet wheel, a leakage-proof gasket is provided.

2. A bicycle hub sealing structure as claimed in claim 1, wherein the inside end of the sleeve oil seal is fitted on the outside wall of the bulge loop, while the outside end is an elastic bent portion resisting against the inside wall of the housing cavity to accomplish a sealing effect.

3. A bicycle hub sealing structure as claimed in claim 2, wherein the bent portion of the sleeve oil seal is bent toward the outside of the housing cavity of the hub enclosure.

4. A bicycle hub sealing structure as claimed in claim 2, wherein the bottom and rear end of the leakage-proof gasket are respectively fitted on the bottom end face of the housing cavity and the external end face of the ratchet wheel, on the middle position, a seal is formed; the top of the seal resists against the inside wall of the bulge loop.

5. A bicycle hub sealing structure as claimed in claim 4, wherein the seal is in an arc shape, with its opening facing toward the bottom end face of the housing cavity.

6. A bicycle hub sealing structure as claimed in claim 1˜5, wherein the inside wall of the hub enclosure is configured with a step, on the axle shaft, a ratchet wheel mounting nut is provided, and positioned through the step, the rear end of the ratchet wheel is connected to the ratchet wheel mounting nut on the axle shaft through threaded joint.

7. A bicycle hub sealing structure as claimed in claim 6, wherein, inside the hub enclosure and the sleeve and outside the first ball bearing and the second ball bearing, a first layer sealing device and a second layer sealing device are respectively provided.

8. A bicycle hub sealing structure as claimed in claim 7, wherein the first layer sealing device and the second layer sealing device are made up of two plane oil seals or one plane oil seal and one waterproof cover.

9. A bicycle hub sealing structure as claimed in claim 8, wherein first layer sealing device and second layer sealing device are of the same structure.

10. A bicycle hub sealing structure as claimed in claim 8, wherein first layer sealing device and second layer sealing device are of different structures.
